(19) United States
(12) Patent Application Publication
(10) Pub. No.: US 2011/0001893 A1
(43) Pub. Date: Jan. 6, 2011

(54) ILLUMINATION DEVICE, DISPLAY DEVICE, AND TELEVISION RECEIVER APPARATUS

(75) Inventor: Kaori Yamamoto, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/867,541

(22) PCT Filed: Jan. 26, 2009
(86) PCT No.: PCT/JP2009/051205

§ 371 Date: Aug. 13, 2010

(30) Foreign Application Priority Data
Feb. 27, 2008 (JP) 2008-046703

(51) Int. Cl. H04N 5/64; F21V 21/00; F21S 4/00; F21V 7/00; G02F 1/13357; G02F 1/1335

(52) U.S. Cl. 348/836; 362/217.11; 362/225; 362/217.05; 362/97.1; 349/61; 348/E05.128

(57) ABSTRACT

An illumination device 12 according to the present invention includes a linear light source 17, a chassis 14 that houses the linear light source 17, and a spacer 41 that is provided between the linear light source 17 and the chassis 14 so as to separate the linear light source 17 from the chassis 14. The spacer 41 is arranged under the linear light source 17 on the chassis 14 when viewed in plan. Since the spacer 41 is provided between the linear light source 17 and the chassis 14 so as to maintain a distance therebetween over a predetermined distance, the spacer 41 does not overlap the linear light source 17. Therefore, dark areas are less likely to be present on the linear light source 17 and thus uniformity of illumination luminance distribution can be ensured.

### TECHNICAL FIELD

The present invention relates to an illumination device, a display device, and a television receiver apparatus.

### BACKGROUND ART

For example, since a liquid crystal panel used in a liquid crystal display device such as a liquid crystal television is not self-luminous, such a liquid crystal panel separately requires a backlight unit as an illumination device. Such a backlight unit is intended to be installed on a rear side (a side opposite to a display surface) of the liquid crystal panel and, for example, includes: a metallic chassis having an opened surface on the liquid crystal panel-side; and a large number of linear light sources (for example, cold cathode tubes) housed in the chassis.

The aforementioned linear light source leaks light, albeit only slightly, to the chassis during lighting. The amount of leakage is inversely proportional to a distance between the linear light source and the chassis. Therefore, a deflection of the linear light source due to its own weight or a partial warpage of the linear light source due to insufficient strength of the chassis may cause a variance in the distances between the respective linear light sources and the chassis and differences in outputted light intensity per linear light source and may create a risk of a display quality loss of the liquid crystal display device. In particular, when the linear light source and the chassis become too close to each other such that a distance therebetween equals or falls below a predetermined distance, an increase in leakage may cause lighting failure of the linear light source. A configuration involving installing a spacer between the linear light source and the chassis is known as a solution to the problem described above (for example, refer to Patent Document 1).

A backlight unit disclosed in Patent Document 1 includes a plurality of linear light sources and a reflector that reflects light from the light sources, wherein a spacer for maintaining a constant interval between the light sources and the reflector along a longitudinal direction of the linear light sources is provided between adjacent light sources with an axial direction position thereof displaced. In addition to maintaining a constant distance between the linear light sources and the reflector, the spacer also functions to restrict displacement of the linear light sources in a direction of juxtaposition thereof, and is configured by opening insertion holes into a plate-like member. By inserting the linear light sources into the insertion holes, the linear light sources become fixed with their peripheral surfaces covered.

Patent Document 1: Japanese Patent Laid-Open No. 2002-333842

### PROBLEMS TO BE SOLVED BY THE INVENTION

Recently, larger and thinner liquid crystal display devices have led to longer linear light sources and thinner chassis. As a result, there is an increased risk of occurrences of deflection of a linear light source or warpage of a chassis. In particular, in order to realize a thinner liquid crystal display device, it is desirable to minimize a distance between a linear light source and a chassis. In this case, a slight change in the distance between the linear light source and the chassis relatively causes a significant variance in leakage. Therefore, there is a greater need to maintain a constant distance between the linear light source and the chassis. A conceivable means for satisfying this need involves increasing the number of spacers interposed therebetween.

However, the spacer described in Patent Document 1 is configured so as to partially cover a peripheral surface of a linear light source in order to suppress displacement of the linear light source. Therefore, outputted light is blocked by the spacer at a part of the linear light source covered by the spacer, resulting in the formation of a dark area that is low in luminosity compared to its surroundings. Increasing the number of installed spacers in this manner may lead to a drop in the luminance of illuminating light from the backlight unit or luminance unevenness of the backlight unit. As a result, the display quality of the liquid crystal display device may decline.

### DISCLOSURE OF THE INVENTION

The present invention has been made based on the circumstances such as described above, and an object thereof is to provide an illumination device with superior uniformity of illumination luminance distribution by maintaining a constant distance between a light source and a chassis. Another object of the present invention is to provide a display device including such an illumination device, and a television receiver apparatus including such a display device.

### MEANS FOR SOLVING THE PROBLEMS

In order to solve the problems described above, an illumination device according to the present invention includes a linear light source, a chassis that houses the linear light source, and a spacer provided between the linear light source and the chassis so as to separate the linear light source from the chassis. The spacer is arranged under the linear light source when viewed in plan.

Such a configuration enables a constant distance to be maintained between the linear light source and the chassis while hardly forming dark areas on the linear light source, and notably restricts the linear light source and the chassis from approaching each other.

When the chassis included in the illumination device is metallic, a slight leak from the linear light source is created. The amount of leakage is inversely proportional to the distance between the linear light source and the chassis. Therefore, for example, when aligning a plurality of linear light sources, a deflection of the linear light sources due to their own weight or a partial warpage of the linear light sources due to insufficient strength of the chassis may cause a variance in the distances between the respective linear light sources and the chassis and differences in outputted light intensity per linear light source. As a result, there is a risk of a display quality loss of the illumination device. In particular, when a linear light source and the chassis become too close to each other such that a distance therebetween equals or falls below a predetermined distance, an increase in leakage may cause lighting failure of the linear light source. In addition, in order to realize a thinner illumination device, it is desirable to minimize a distance between a linear light source and a chassis. In this case, a slight change in the distance between the linear light source and the chassis relatively causes a significant variance in leakage.

According to a configuration of the present invention, a spacer is provided interposed between the linear light source and the chassis in order to maintain a constant distance between the linear light source and the chassis. Since the spacer suppresses the linear light source and the chassis from approaching each other by being interposed between the linear light source and the chassis, the spacer does not cover the linear light source. Therefore, dark areas are less likely to be present at the linear light source. In addition, by providing the spacer at a position overlapping the linear light source in plan view, a shadow is less likely to be created by the outputted light from the linear light source. Therefore, the distance between the linear light source and the chassis can be restricted from falling below a predetermined distance without dark areas on the linear light source. As described above, by providing the spacer, a situation where the linear light source and the chassis excessively approach each other, which must be particularly avoided, can be suppressed. As a result, a uniform illumination luminance distribution free of luminance unevenness can be realized while hardly forming dark areas on the linear light source.

### BRIEF DESCRIPTION OF THE DRAWINGS

FIG. 1 is an exploded perspective view illustrating a schematic configuration of a television receiver apparatus according to a first embodiment of the present invention;

FIG. 2 is an exploded perspective view illustrating a schematic configuration of a liquid crystal display device included in the television receiver apparatus;

FIG. 3 is a cross-sectional view illustrating a cross-sectional configuration of the liquid crystal display device in a short-side direction thereof;

FIG. 4 is a cross-sectional view illustrating a cross-sectional configuration of the liquid crystal display device in a long-side direction thereof;

FIG. 5 is a cross-sectional view illustrating a configuration of a lamp clip included in the liquid crystal display device;

FIG. 6 is a plan view illustrating a configuration of a chassis included in the liquid crystal display device;

FIG. 7 is a perspective view illustrating a schematic configuration of a spacer sheet;

FIG. 8 is a cross-sectional view illustrating a mounted state of the spacer sheet in a long-side direction thereof;

FIG. 9 is a cross-sectional view illustrating a mounted state of the spacer sheet in a short-side direction thereof;

FIG. 10 is a perspective view illustrating a schematic configuration of a spacer sheet according to a second embodiment of the present invention;

FIG. 11 is a cross-sectional view illustrating a mounted state of the spacer sheet to a chassis;

FIG. 12 is a perspective view illustrating a schematic configuration of a spacer sheet according to a third embodiment of the present invention;

FIG. 13 is a cross-sectional view illustrating a mounted state of the spacer sheet to a chassis;

FIG. 14 is a perspective view illustrating a schematic configuration of a spacer sheet according to a fourth embodiment of the present invention;

FIG. 15 is a cross-sectional view illustrating a mounted state of the spacer sheet to a chassis;

FIG. 16 is a cross-sectional view illustrating a mounted state of a spacer sheet to a chassis according to a fifth embodiment of the present invention;

FIG. 17 is a cross-sectional view illustrating a mounted state of a spacer sheet to a chassis according to a sixth embodiment of the present invention;

FIG. 18 is a cross-sectional view illustrating a mounted state of a spacer sheet to a chassis according to a seventh embodiment of the present invention;

FIG. 19 is a cross-sectional view illustrating a mounted state of a spacer to a chassis according to an eighth embodiment of the present invention;

FIG. 20 is a plan view illustrating a modification of a mounting mode of a spacer sheet;

FIG. 21 is a perspective view illustrating a modification of a shape of a spacer;

FIG. 22 is a perspective view illustrating a modification of a shape of a spacer;

FIG. 23 is a perspective view illustrating a modification of a shape of a spacer; and

FIG. 24 is a plan view illustrating a modification of a shape of a spacer sheet.

### BEST MODE FOR CARRYING OUT THE INVENTION

### First Embodiment

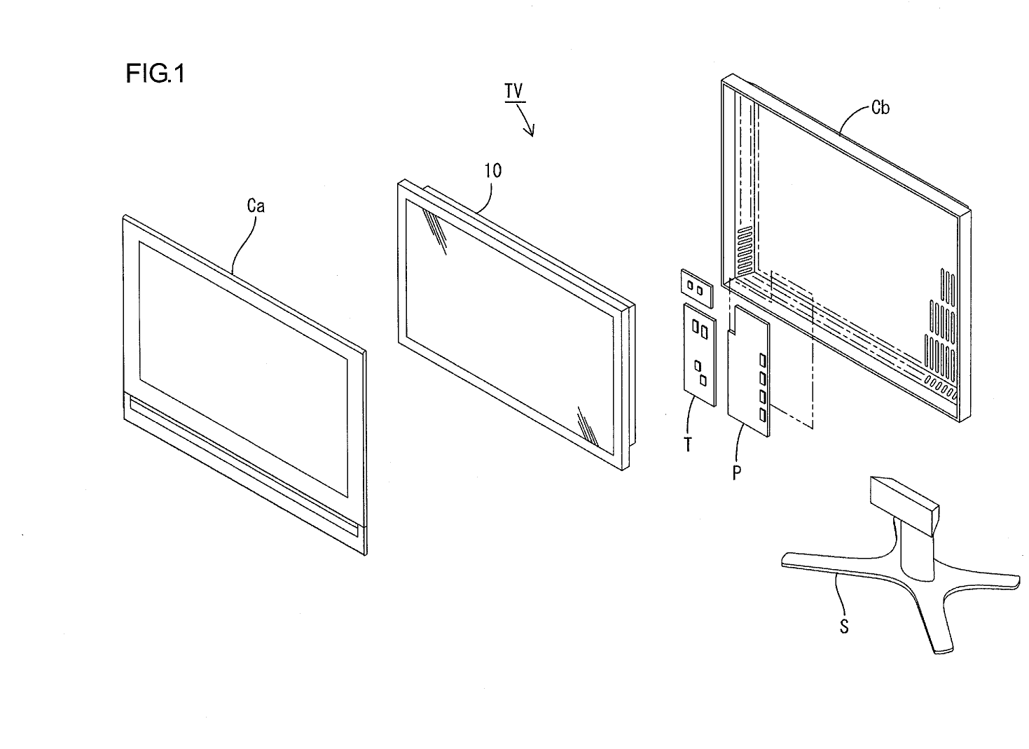

A first embodiment of the present invention will be described with reference to FIGS. 1 to 9. First, a configuration of a television receiver apparatus TV including a liquid crystal display device 10 will be described with reference to FIGS. 1 to 6.

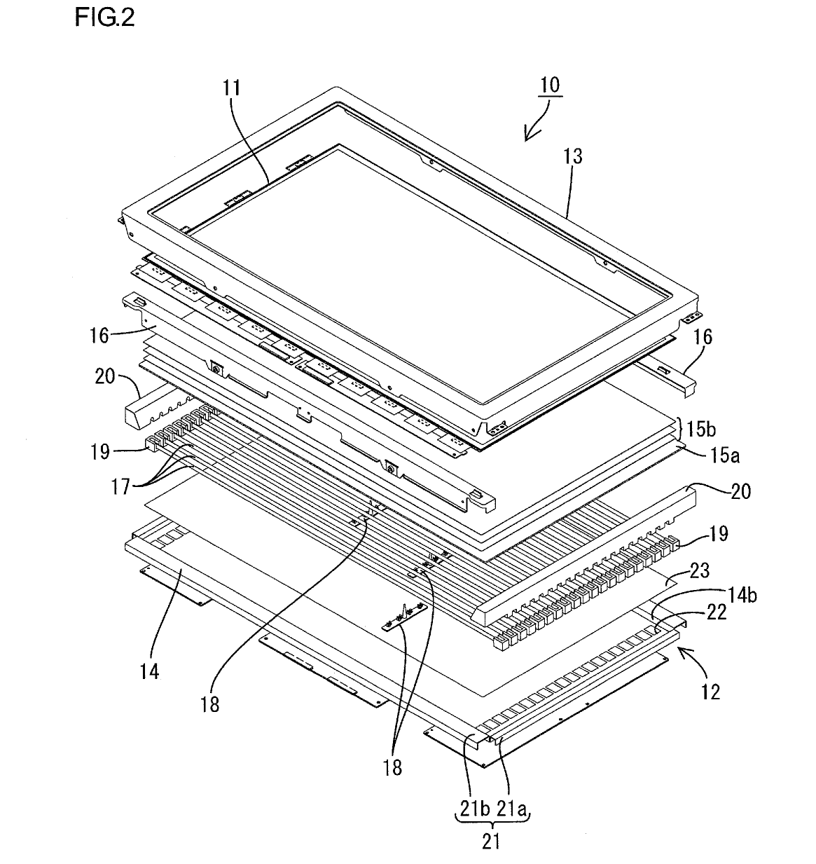

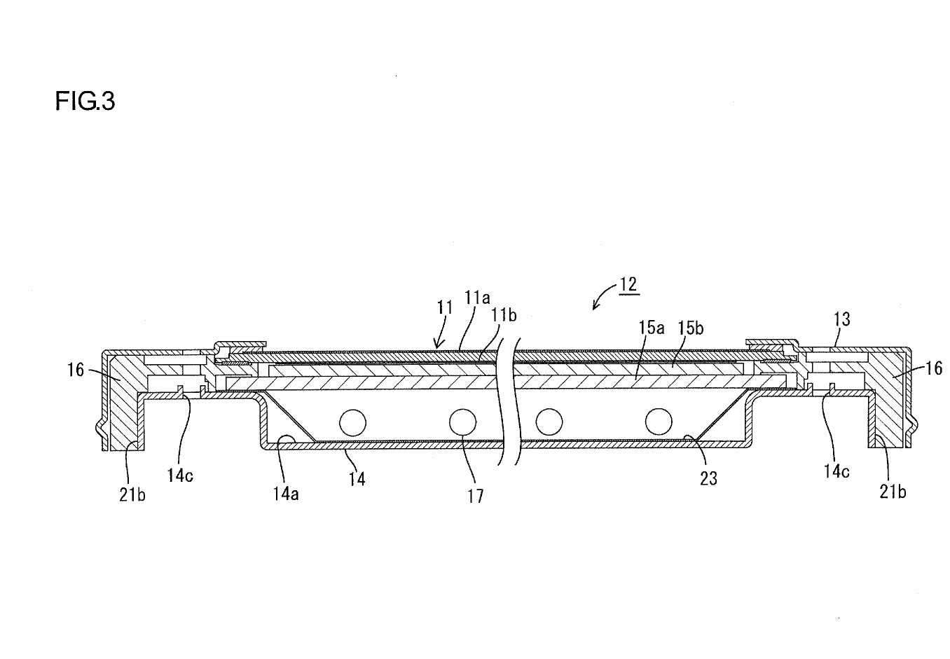

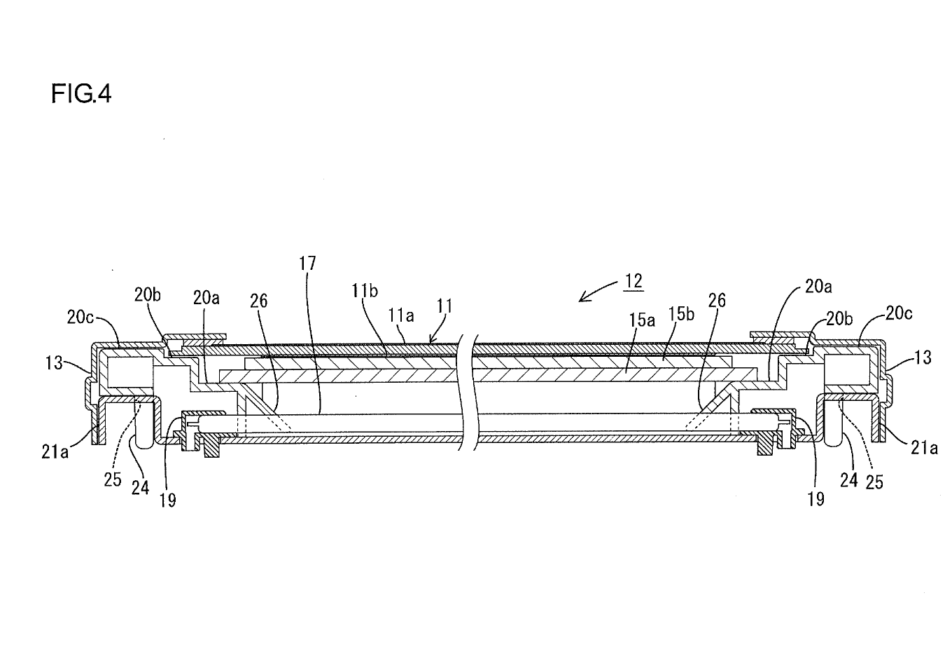

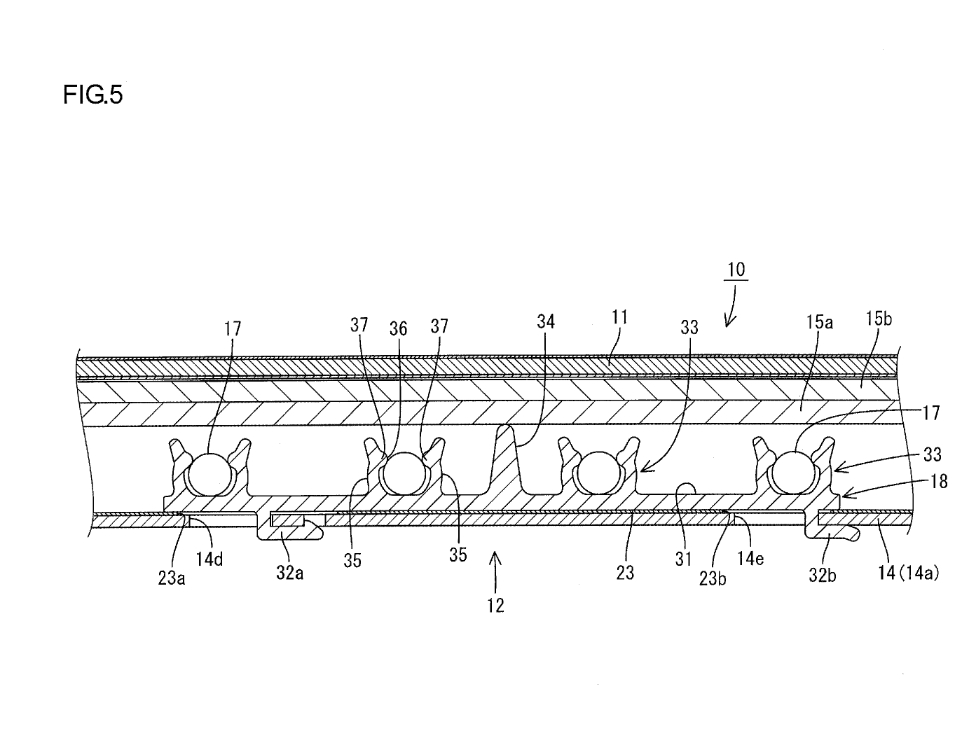

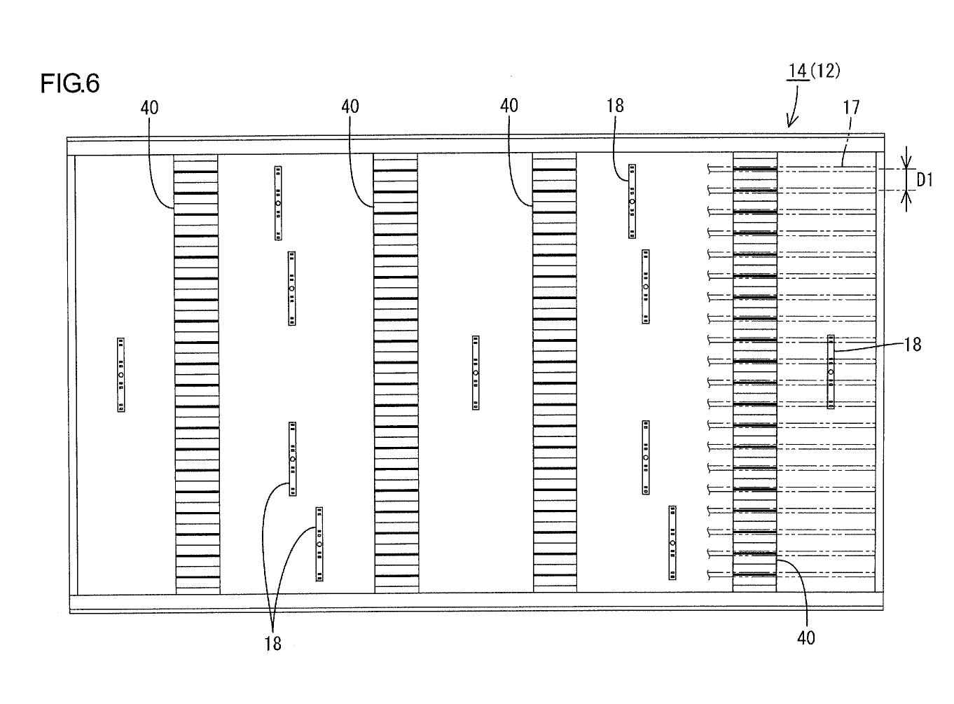

FIG. 1 is an exploded perspective view illustrating a schematic configuration of the television receiver apparatus according to the present embodiment. FIG. 2 is an exploded perspective view illustrating a schematic configuration of a liquid crystal display device included in the television receiver apparatus illustrated in FIG. 1. FIG. 3 is a cross-sectional view illustrating a cross-sectional configuration in a short-side direction of the liquid crystal display device illustrated in FIG. 2. FIG. 4 is a cross-sectional view illustrating a cross-sectional configuration in a long-side direction of the liquid crystal display device illustrated in FIG. 2. FIG. 5 is a cross-sectional view illustrating a configuration of a lamp clip included in the liquid crystal display device illustrated in FIG. 2. FIG. 6 is a plan view illustrating a configuration of a chassis included in the liquid crystal display device illustrated in FIG. 2.

As illustrated in FIG. 1, the television receiver apparatus TV according to the present embodiment includes: the liquid crystal display device 10; front and rear cabinets Ca and Cb which house the liquid crystal display device 10 so as to sandwich the same; a power source P; a tuner T; and a stand S. The liquid crystal display device (display device) 10 as a whole forms a horizontally long rectangle and is housed in an upright state. As illustrated in FIG. 2, the liquid crystal display device 10 includes a liquid crystal panel 11 that is a display panel and a backlight unit (illumination device) 12 that is an external light source. The liquid crystal panel 11 and the backlight unit 12 are integrally held by a frame-like bezel 13 and the like.

Next, the liquid crystal panel 11 and the backlight unit 12 which make up the liquid crystal display device 10 will be described (refer to FIGS. 2 to 4).

For the liquid crystal panel (display panel) 11, a pair of glass substrates is pasted together while being separated by a predetermined gap and liquid crystals are sealed between the two glass substrates. One of the glass substrates is provided with a switching element (for example, a TFT) connected to a source wiring and a gate wiring that intersect each other at right angles, a pixel electrode connected to the switching element, an alignment layer, and the like. The other glass substrate is provided with a color filter on which respective colored portions such as R (red), G (green) and B (blue) are arranged in a predetermined alignment, a counter electrode, an alignment layer, and the like. Moreover, polarizing plates 11a and 11b are arranged on the outsides of both substrates (refer to FIGS. 3 and 4).

As illustrated in FIG. 2, the backlight unit 12 includes: an approximately box-shaped chassis 14 having an opening 14b on a light outputting surface-side (a side of the liquid crystal panel 11); a diffusing plate 15a arranged so as to cover the opening 14b of the chassis 14; a plurality of optical sheets 15b arranged between the diffusing plate 15a and the liquid crystal panel 11; and a frame 16 which is arranged along a long side of the chassis 14 and which holds a long-side edge part of the diffusing plate 15a by sandwiching the same between the chassis 14. Furthermore, the chassis 14 is interiorly provided with: a cold cathode tube (linear light source) 17; a lamp clip (light source gripping member) 18 for mounting the cold cathode tube 17 to the chassis 14; relay connectors 19 responsible for relaying electrical connections at each end part of the cold cathode tube 17; and a holder 20 that covers all of the end parts of the cold cathode tube 17 and the group of relay connectors 19. Moreover, at the backlight unit 12, the diffusing plate 15a is closer to the light output side than the cold cathode tube 17.

The chassis 14 is metallic and is sheet-metal processed and molded into a shallow, approximately box shape made up of: a rectangular bottom plate 14a; and a folded outer edge part 21 rising from the respective sides of the bottom plate 14a and folded in an approximate U-shape (a folded outer edge part 21a in a short-side direction and a folded outer edge part 21b in a long-side direction). A plurality of relay connector mounting holes 22 for mounting the relay connectors 19 is drilled on both longitudinal end parts of the bottom plate 14a of the chassis 14. In addition, as illustrated in FIG. 3, a fixing hole 14c is drilled into an upper surface of the folded outer edge part 21b of the chassis 14. For example, the fixing hole 14c enables the bezel 13, the frame 16, the chassis 14 and the like to be integrated by a screw or the like.

A reflection sheet 23 is arranged on an inner surface-side (a side of the surface opposite the cold cathode tube 17) of the bottom plate 14a of the chassis 14. The reflection sheet 23 is made of synthetic resin, has a surface colored white that is a color with superior light reflectivity, and is laid along an inner surface of the bottom plate 14a of the chassis 14 so as to approximately cover the entire area of the bottom plate 14a of the chassis 14. As illustrated in FIG. 3, a long-side edge part of the reflection sheet 23 rises so as to cover the folded outer edge part 21 of the chassis 14 and is sandwiched between the chassis 14 and the diffusing plate 15a. The reflection sheet 23 enables light emitted from the cold cathode tube 17 to be reflected to the side of the diffusing plate 15a.

Meanwhile, the diffusing plate 15a and an optical sheet 15b are arranged on the chassis 14 on the side of the opening 14b. The diffusing plate 15a is a synthetic resin plate-like member dispersedly mixed with light-scattering particles and functions to diffuse linear light emitted from the cold cathode tube 17 that is a tubular light source. As described above, the short-side edge part of the diffusing plate 15a is mounted on the first surface 20a of the holder 20 and is configured so as to be unaffected by vertical binding forces. On the other hand, as illustrated in FIG. 3, the long-side edge part of the diffusing plate 15a is sandwiched between and therefore fixed by the chassis 14 (reflection sheet 23) and the frame 16.

The optical sheet 15b arranged on the diffusing plate 15a is a laminated structure of a diffusing sheet, a lens sheet, and a reflective polarizing plate, in this order, from the side of the diffusing plate 15a, and functions to convert light emitted from the cold cathode tube 17 and passed through the diffusing plate 15a into planar light. The liquid crystal panel 11 is placed on an upper surface-side of the optical sheet 15b. The optical sheet is held between the diffusing plate 15a and the liquid crystal panel 11.

The cold cathode tube 17 has an elongated tubular shape. A large number of the cold cathode tubes 17 are housed in the chassis aligned parallel to each other in a state where a longitudinal direction (an axial direction) of the tubes is matched with the long-side direction of the chassis 14 (refer to FIGS. 2 and 4). The cold cathode tube 17 is gripped by the lamp clip 18 (not illustrated in FIGS. 3 and 4) such that a slight gap is provided between the cold cathode tube 17 and the bottom plate 14a (reflection sheet 23) of the chassis 14. Each end part of the cold cathode tube 17 is fit into the relay connector 19. The holder 20 is mounted so as to cover the relay connectors 19.

The lamp clip 18 is made of synthetic resin (for example, polycarbonate) and has a surface colored white that is a color with superior light reflectivity. As illustrated in FIG. 5, the lamp clip 18 has an approximately plate-like shape along the bottom plate 14a (reflection sheet 23) of the chassis 14 and includes a base plate portion 31 that is approximately rectangular as seen in plan view. The lamp clip 18 is mounted to the chassis 14 in a posture where a longitudinal direction of the base plate portion 31 becomes approximately parallel to a short-side direction of the chassis 14 (i.e., a direction of juxtaposition of the cold cathode tube 17). Approximately L-shaped mounting portions 32a and 32b are formed on a rear-side surface (a surface opposite the reflection sheet 23, a surface on the side of the bottom plate 14a of the chassis 14) of the base plate portion 31. The lamp clip 18 is fixed to the chassis 14 when the mounting portions 32a and 32b are respectively inserted into insertion holes 23a and 23b and mounting holes 14d and 14e formed on the reflection sheet 23 and on the bottom plate 14a of the chassis 14.

Meanwhile, a front-side surface (a surface opposite the diffusing plate 15a and the cold cathode tube 17, a surface opposite to the bottom plate 14a of the chassis 14) of the base plate portion 31 is provided with a light source gripping portion 33 for supporting the cold cathode tube 17 at a predetermined vertical position and a supporting pin 34 for supporting the diffusing plate 15a to a position higher than the cold cathode tube 17.

The light source gripping portion 33 has an open-ended ring shape opened to the side opposite to the base plate portion 31. A plurality (four in the present embodiment) of the light source gripping portions 33 is arranged aligned at positions separated from each other in the longitudinal direction of the base plate portion 31 and respectively grip a different cold cathode tube 17. Spacing between the respective light source gripping portions 33 is consistent with the spacing between the respective cold cathode tubes 17 juxtaposed in the chassis 14. The light source gripping portion 33 includes a pair of arm portions 35 that face each other. An opening 36 that permits attachment/detachment of the cold cathode tube 17 is provided between the tips of both arm portions 35, 35. Both arm portions 35 are configured so as to be elastically deformable at least in a width-changing direction of the opening 36.

The pair of arm portions 35 has cantilever forms which respectively rise from positions on a front surface of the base plate portion 31 and which are separated from each other in a longitudinal direction thereof, and has shapes bent in an approximate arc. The curvature of both arm portions 35 is approximately consistent with a curvature of an outer circumferential surface of the cold cathode tube 17. Holding projections 37 for holding the cold cathode tube 17 are respectively provided on inner surfaces (surfaces opposing the cold cathode tube 17) of the tips of both arm portions 35. The aforementioned opening 36 is secured between both holding projections 37. The clearance of the opening 36 is set so as to be slightly narrower than an outside diameter of the cold cathode tube 17. Therefore, both arm portions 35 are configured so as to be elastically expanded and deformed when pushed by the cold cathode tube 17 during attachment or detachment of the cold cathode tube 17 through the opening 36.

The aforementioned light source gripping portion 33 is capable of supporting the cold cathode tube 17 at a vertical position slightly elevated (separated) from the chassis 14 (reflection sheet 23) by gripping a central part between both end parts at which electrodes are set among the cold cathode tube 17 or, in other words, a light emitting portion of the cold cathode tube 17. More specifically, holding projections 37 on the tips of the arm portions 35 abut the outer circumferential surface of the cold cathode tube 17, and the entire arm portions 35 enter a state where the arm portions 35 cover parts of the cold cathode tube 17 with the exception of a surface on the side of the diffusing plate 15a while keeping a slight gap between the outer circumferential surface of the cold cathode tube 17.

Meanwhile, the supporting pin 34 is set so as to protrude from a central position in the longitudinal direction of the base plate portion 31 and functions to restrict warping of the diffusing plate 15a to the side of the cold cathode tube 17 by supporting the diffusing plate 15a from the rear surface-side at a part closer to the center of the screen than an outer peripheral edge part supported by the holder 20 and the like. The supporting pin 34 is configured such that the shape of a cross section thereof cut along a planar direction of the diffusing plate 15a is circular and is formed so as to have an approximately conical shape whose diameter gradually decreases from a root side towards a tip side. In addition, a tip of the supporting pin 34 capable of coming into contact with the diffusing plate 15a is formed with an R surface.

A protruding height of the supporting pin 34 (a height from the base plate portion 31 to the tip part of the supporting pin 34) is set higher than the light source gripping portion 32. Accordingly, the supporting pin 34 is a portion that protrudes the highest among the lamp clip 18. Therefore, when performing an attaching/detaching operation of the lamp clip 18 to/from the chassis 14, a worker can perform the operation by grasping the supporting pin 34, thereby enabling the supporting pin 34 to also function as an operating unit during attachment/detachment.

As illustrated in FIG. 6, the lamp clips 18 are installed at a plurality of positions dispersed on inner surfaces of the bottom plate 14a of the chassis 14 and the reflection sheet 23. The arrangement of the lamp clips 18 will be described in detail below. The lamp clips 18 are arranged away from each other in the long-side direction of the chassis 14 and the reflection sheet 23 so as to hold the cold cathode tubes 17 at a plurality of positions in an axial direction. The spacer sheet 40 having spacers 41 that will be described later is placed between the lamp clips 18.

Furthermore, in the short-side direction of the chassis 14, adjacent lamp clips 18 are arranged at positions mutually displaced in the long-side direction of the chassis 14 instead of at linearly arranged positions. Therefore, compared to a hypothetical case where the respective lamp clips 18 are aligned in a single row along the short-side direction, the dispersed arrangement of the respective lamp clips 18 in the plane of the reflection sheet 23 makes shadows of the lamp clips 18 less visible due to characteristics of the human eye. In other words, even if the number of the lamp clips 18 is the same, an aligned or concentrated arrangement makes the lamp clips 18 more visible due to characteristics of the human eye. On the other hand, by arranging the lamp clips 18 so as to be dispersed as in the present embodiment, luminance unevenness is less likely to occur at the backlight unit 12 even if light reflectance differs between the reflection sheet 23 and the lamp clips 18.

Moreover, the present embodiment is configured such that: the used cold cathode tube 17 has a tube diameter of 4.0 mm; the distance between the cold cathode tube 17 and the bottom plate 14a of the chassis 14 is set to 0.8 mm; the distance between adjacent cold cathode tubes 17 is set to 16.4 mm; and the distance between the cold cathode tube 17 and the diffusing plate 15a is set to 2.7 mm. As shown, thinning is applied between the respective components in the backlight unit 12. In particular, the distance between the cold cathode tube 17 and the diffusing plate 15a and the distance between the cold cathode tube 17 and the bottom plate 14a of the chassis 14 have been reduced. Due to such thinning of the backlight unit 12, a thickness of the liquid crystal display device 10 (i.e., a thickness from a front surface of the liquid crystal panel 11 to a rear surface of the backlight unit 12) of 16 mm and a thickness of the television receiver apparatus TV (i.e., a thickness from a front surface of the front-side cabinet Ca to a rear surface of the rear-side cabinet Cb) of 34 mm are realized. As a result, a thin television receiver apparatus is realized.

The holder 20 covering end parts of the cold cathode tubes 17 is made of white synthetic resin and, as illustrated in FIG. 2, has an approximately elongated box shape extending in the short-side direction of the chassis 14. As illustrated in FIG. 4, the holder 20 has a stepped surface configured such that the diffusing plate 15a and the liquid crystal panel 11 can be mounted on different levels of a front surface-side of the stepped surface. The holder 20 is arranged so as to partially overlap with the folded outer edge part 21a in the short-side direction of the chassis 14 and, together with the folded outer edge part 21a, forms a side wall of the backlight unit 12. An insertion pin 24 protrudes from a surface of the holder 20 opposite the folded outer edge part 21a of the chassis 14. The holder 20 is mounted onto the chassis 14 by inserting the insertion pin 24 into an insertion hole 25 formed on an upper surface of the folded outer edge part 21a of the chassis 14.

The stepped surface of the holder 20 is made up of three surfaces parallel to the bottom plate 14a of the chassis 14. A short-side edge part of the diffusing plate 15a is mounted on a lowermost first surface 20a of the stepped surface of the holder 20. In addition, an inclined cover 26 that inclines toward the bottom plate 14a of the chassis 14 extends from the first surface 20a. A short-side edge part of the liquid crystal panel 11 is mounted on a second surface 20b among the stepped surface of the holder 20. A topmost third surface 20c of the stepped surface of the holder 20 is arranged at a position overlapping the folded outer edge part 21a of the chassis 14 and is in contact with the bezel 13.

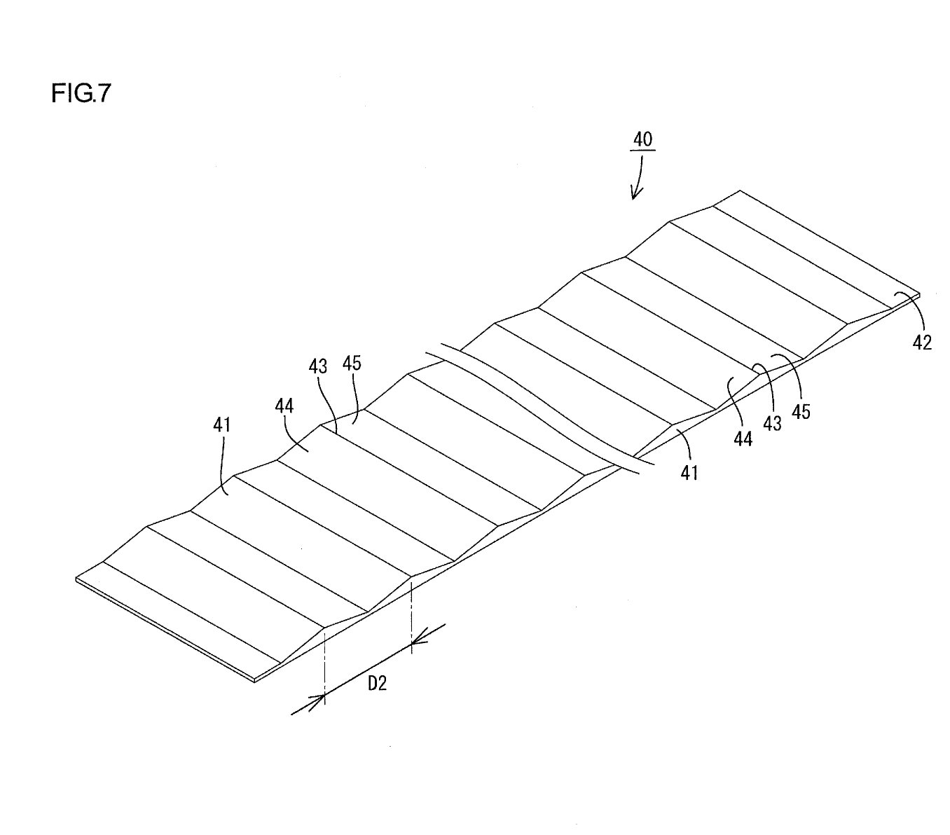

The spacer sheet 40 (not illustrated in FIGS. 2 to 4) placed such that a longitudinal direction thereof is consistent with a direction of juxtaposition of the cold cathode tubes 17 will now be described in detail with reference to FIGS. 7 to 9.

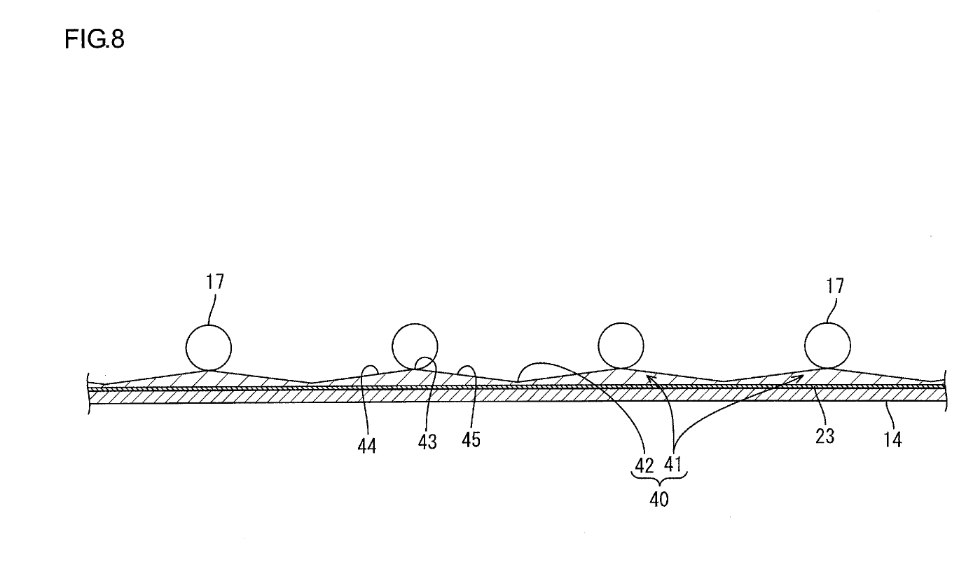

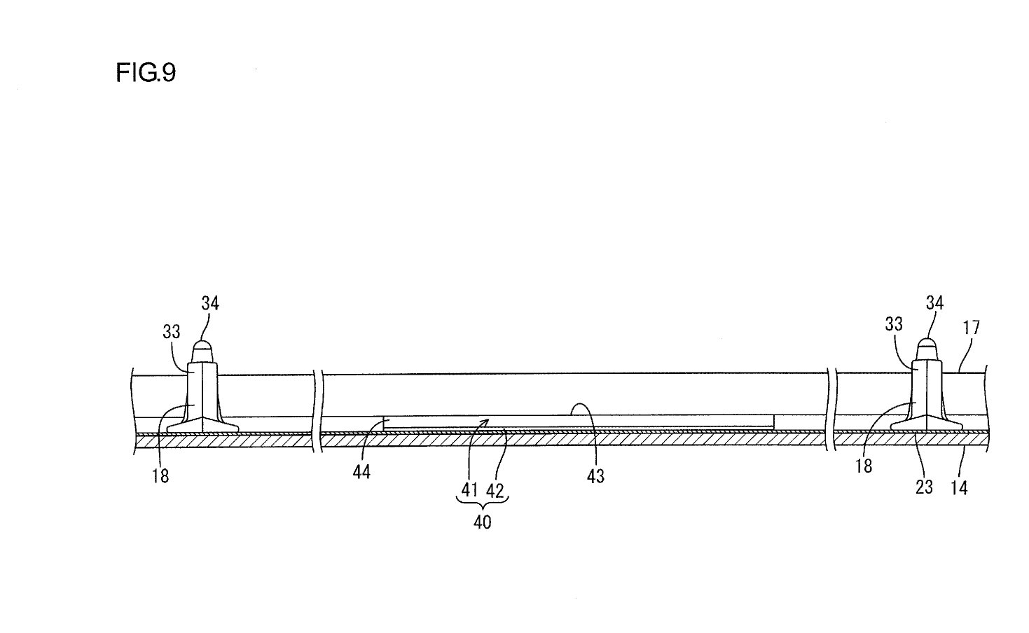

FIG. 7 is a perspective view illustrating a schematic configuration of a spacer sheet. FIG. 8 is a cross-sectional view illustrating a mounted state of the spacer sheet illustrated in FIG. 7 in a long-side direction thereof. FIG. 9 is a cross-sectional view illustrating a mounted state of the spacer sheet illustrated in FIG. 7 in a short-side direction thereof.

As described above, the spacer sheet 40 is to be laid so that the longitudinal direction thereof is consistent with a direction of juxtaposition of the cold cathode tubes 17. As illustrated in FIG. 7, the spacer sheet 40 is configured such that a plurality of spacers 41 that are protrusion strips with triangular cross sections is arranged on a belt-like base plate sheet 42. More specifically, a plurality of (in the present embodiment, 20 that is the same as the number of aligned cold cathode tubes 17) spacers 41 are juxtaposed with striation (hereinafter, referred to as a ridge 43) directions thereof consistent to each other. The spacer sheet 40 may either be integrated after separately forming the spacers 41 and the base plate sheet 42 or formed by integral molding.

The spacer 41 made of synthetic resin (for example, made of foamed polyethylene terephthalate) has a surface colored white that is a color with superior light reflectivity, has a rectangular shape in plan view, and is a protrusion strip extending along the long-side direction. An end surface of the spacer 41 on a side opposite the cold cathode tube 17 has a sharp point and forms the ridge 43, and includes inclined surfaces 44 and 45 that slope from the ridge 43 to the base plate sheet 42. Viewed from a direction of a vertical cross section, the spacer 41 is an isosceles triangle where lengths of sides forming the inclined surfaces 44 and 45 are the same. The spacer 41 has a ridge-like shape that spreads toward the chassis 14 side, that is, a width of which on the chassis 14 side is larger than on the cold cathode tube 17 side. The spacer 41 is successively formed on the base plate sheet 42 so that inclined surfaces 44 and 45 of an adjacent spacer 41 rise from a tangential line formed by the inclined surfaces 44 and 45 of the spacer 41 and the base plate sheet 42. An interval D2 between ridges 43 of adjacent spacers 41 is set the same as an interval D1 between the aforementioned cold cathode tubes 17 (refer to FIG. 6). In addition, in the present embodiment, a height from the ridge 43 of the spacer 41 to the rear surface of the base plate sheet 42 or, in other words, a height of the spacer sheet 40 is set consistent with the distance between the aforementioned cold cathode tube 17 and the reflection sheet 23.

The base plate sheet 42 is made of synthetic resin (for example, foamed polyethylene terephthalate) and is configured as an ultra-thin belt-like body that is sufficiently long to overlap the cold cathode tube 17 along the direction of juxtaposition of the same. Spacers 41 are successively formed on a front-side surface (a surface opposite the cold cathode tube 17, a surface on the opposite side to the bottom plate 14a of the chassis 14) of the base plate sheet 42 with slight gaps provided at both end parts of the base plate sheet 42 in the long-side direction thereof. On the other hand, an adhesive layer for pasting the spacer sheet 40 to the reflection sheet 23 (chassis 14) is formed on a rear-side surface of the base plate sheet 41 or, in other words, a surface on a side opposite to the side on which the spacers 41 are formed.

The spacer sheet 40 including the spacers 41 and the base plate sheet 42 described above is pasted to the reflection sheet 23 with the long-side direction of the spacer sheet 40 conformed with the direction of juxtaposition of the cold cathode tubes 17 in the form of being incorporated into a gap between the juxtaposed cold cathode tubes 17 and the chassis 14 (reflection sheet 23). As illustrated in FIG. 8, the spacer sheet 40 is pasted such that the spacers 41 are arranged under the cold cathode tubes 17 when viewed in plan. More specifically, in a form where the ridges 43 of the spacers 41 are consistent with axial lines of the cold cathode tubes 17. In this case, the height of the spacer sheet 40 (the height from the ridges 43 to the rear surface of the base plate sheet 42) is set consistent with the distance between the cold cathode tubes 17 and the reflection sheet 23. Therefore, as illustrated in FIG. 9, the ridges 43 of the spacer 41 come into line contact (point contact in FIG. 8) with the cold cathode tubes 17. Accordingly, at portions where the spacers 41 are interposed between the cold cathode tubes 17 and the bottom plate 14a of the chassis 14, the cold cathode tubes 17 and the chassis 14 are suppressed (restricted) from approaching each other because the spacers 41 inhibit even a slightest decrease in the distance between the cold cathode tubes 17 and the chassis 14. As described above, a configuration where the spacers 41 and the cold cathode tubes 17 come into contact with each other so as to deny the cold cathode tubes 17 and the chassis 14 from even slightly approaching each other is favorably applied to a thin backlight unit 12 such as that described in the present embodiment.

In addition, in the long-side direction of the chassis 14 (axial direction of the cold cathode tubes 17), as illustrated in FIG. 6, two spacer sheets 40 are arranged parallel to and separated from each other between two lamp clips 18, 18 separated from each other and gripping a single cold cathode tube 17. The respective spacer sheets 40 do not approach the lamp clips 18 and are laid separated from each other by a predetermined distance in the axial direction of the cold cathode tubes 17. The length of the spacer sheet 40 in the long-side direction thereof is set approximately the same as the length of the chassis 14 in the short-side direction thereof. The respective spacer sheets 40 are laid across both short-side end parts of the chassis 14.

The arrangement of the spacer sheets 40 between lamp clips 18 arranged separated from each other is due to the following reason. At portions where the lamp clips 18 are arranged, the cold cathode tube 17 is gripped by the lamp clips 18 and, consequently, a constant distance between the cold cathode tube 17 and the chassis 14 is maintained. However, between lamp clips 18 that grip the cold cathode tube 17 at portions separated from each other, the distance between the cold cathode tube 17 and the chassis 14 may vary due to deflection of the cold cathode tube 17 or distortion of the chassis 14. In consideration thereof, a configuration is adopted where the spacer sheet 40 (the spacers 41) is arranged between separately arranged lamp clips 18, 18 to restrict the cold cathode tube 17 and the chassis 14 from approaching each other.

The spacer 41 is formed such that a width of the portion (ridge 43) that is opposite the cold cathode tube 17 smaller than the width of the cold cathode tube 17. In particular, in the present embodiment, the ridge 43 of the spacer 41 is configured so as to come into line contact with the cold cathode tube 17. Therefore, since the area of the cold cathode tube 17 covered by the spacer 41 is extremely small, light emitted from the cold cathode tube 17 to the side of the spacer 41 is not blocked by the spacer 41 and dark areas are less likely formed. In addition, since outputted light from the cold cathode tube 17 is reflected to the side of the liquid crystal panel 11 (the side of the light-diffusing plate 15a, the side opposite to the bottom plate 14a of the chassis 14) by the inclined surfaces 44 and 45 formed on the spacer 41, a decline in illumination luminance of the backlight unit 12 can be suppressed without reducing the use efficiency of outputted light.

As described above, according to the present embodiment, the backlight unit 12 includes a spacer 41 provided between a cold cathode tube 17 and a bottom plate 14a of a chassis 14 so as to separate the cold cathode tube 17 from the bottom plate 14a. The spacer 41 is arranged under the cold cathode tube 17 when viewed in plan.

Such a configuration enables a constant distance to be maintained between the cold cathode tube 17 and the chassis 14 and, notably, restricts the cold cathode tube 17 and the chassis 14 from approaching each other while hardly forming dark areas on the cold cathode tube 17.

When a variance occurs in the distance between the respective cold cathode tubes 17 and the chassis 14, a variance also occurs in the leakage from the cold cathode tubes 17 to the chassis 14, resulting in a different output light intensity for each cold cathode tube 17. In particular, when the cold cathode tube 17 and the chassis 14 become too close to each other such that a distance therebetween equals or falls below a predetermined distance, an increase in leakage may cause lighting failure of the cold cathode tube 17. With a thinned backlight unit 12 such as the case in the present embodiment, since the distance between the cold cathode tube 17 and the chassis 14 has been minimized to begin with, even a slight change in the distance therebetween relatively results in a significant variance in leakage. Therefore, for the interest of thinning of the backlight unit 12, it is important that means be adopted for maintaining a constant distance between the cold cathode tube 17 and the chassis 14 and, particularly, for suppressing the cold cathode tube 17 and the chassis 14 from excessively approaching each other.

In consideration thereof, the present embodiment is configured such that the spacer 41 is interposed between the cold cathode tube 17 and the chassis 14. Since the spacer 41 does not grip the cold cathode tube 17 as is the case with the lamp clip 18 and is interposed between the cold cathode tube 17 and the chassis 14 so as to restrict the cold cathode tube 17 and the chassis 14 from excessively approaching each other, the cold cathode tube 17 is not covered and dark areas are unlikely to be formed at the cold cathode tube 17. Accordingly, the distance between the cold cathode tube 17 and the chassis 14 can be suppressed from falling below a predetermined distance without forming dark areas on the cold cathode tube 17. As a result, a uniform illumination luminance distribution free of luminance unevenness can be realized by the backlight unit 12 while hardly forming dark areas on the cold cathode tube 17.

According to the present embodiment, a plurality of lamp clips 18 that grip the cold cathode tube 17 so as to hole the cold cathode tube 17 away from the chassis 14 is arranged separated in an axial direction of the cold cathode tube 17, and the spacer 41 is arranged between the lamp clips 18.

As shown, by providing twofold distance restricting means involving arranging lamp clips 18 in addition to spacers 41, the distance between the cold cathode tube 17 and the chassis 14 can be more reliably restricted.

The lamp clips 18 are for gripping the cold cathode tube 17 or, in other words, for fixing a position of the cold cathode tube 17. Therefore, the distance between the cold cathode tube 17 and the chassis 14 is unlikely to fluctuate at parts where the lamp clips 18 are arranged. On the other hand, there is a risk that the cold cathode tube 17 and the chassis 14 may approach each other between a portion of the cold cathode tube 17 that is gripped by one lamp clip 18 and a portion that is gripped by another lamp clip 18 because there is nothing that restricts the distance between the cold cathode tube 17 and the chassis 14. When the number of lamp clips 18 gripping a single cold cathode tube 17 is hypothetically increased, there may be cases where output light from the cold cathode tube 17 is blocked by the lamp clips 18 because the lamp clips 18 cover a part of the cold cathode tube 17. In such a case, there is a risk that a large numbers of dark areas may be formed in an axial direction of the cold cathode tube 17, resulting in luminance unevenness of the backlight unit 12.

In consideration thereof, the present embodiment is configured such that spacers 41 instead of lamp clips 18 are provided between separately arranged lamp clips 18, 18. Since the spacer 41 is not for gripping the cold cathode tube 17 such as the case with the lamp clip 18 and is interposed between the cold cathode tube 17 and the chassis 14 to restrict the cold cathode tube 17 and the chassis 14 from excessively approaching each other, the cold cathode tube 17 is not covered and dark areas are unlikely to be formed at the cold cathode tube 17. Accordingly, the distance between the cold cathode tube 17 and the chassis 14 can be suppressed from falling below a predetermined distance between the lamp clips 18 without forming dark areas on the cold cathode tube 17.

As described above, the lamp clip 18 suppresses a variance in distance between the cold cathode tube 17 and the chassis 14 by gripping the cold cathode tube 17. The spacer 41 is provided so as to separate the cold cathode tube 17 from the chassis 14. Therefore, the distance between the cold cathode tube 17 and the chassis 14 can be held constant. This is especially effective for restricting the cold cathode tube 17 from coming too close to the chassis 14, which needs to be avoided. As a result, a uniform illumination luminance distribution free of luminance unevenness can be realized while hardly forming dark areas on the cold cathode tube 17.

In addition, according to the present embodiment, the spacer 41 is configured so as to have inclined surfaces 44 and 45 forming a ridge-like spreading from the side of the cold cathode tube 17 to the side of the chassis 14.

Such a configuration enables light emitted from the cold cathode tube 17 to the side of the spacer 41 to be peripherally retrieved along surfaces (inclined surfaces 44 and 45) of the spacer 41 forming the ridge-like shape. Therefore, a high outputted light use efficiency can be achieved and the formation of dark areas at portions where the spacer 41 is provided can be suppressed.

In addition, according to the present embodiment, an end surface opposite the cold cathode tube 17 among the spacer 41 forms a linear ridge 41 and the end surface is configured smaller than the width of the cold cathode tube 17.

Accordingly, since a portion of the cold cathode tube 17 covered by the spacer 41 becomes smaller, the use efficiency of light emitted from the cold cathode tube 17 can be further increased. Therefore, the configuration is extremely effective in resolving dark areas formation.

Furthermore, according to the present embodiment, the surface of the spacer 41 is configured so as to have light reflectivity.

In this case, since light emitted from the cold cathode tube 17 to the side of the spacer 41 is reflected off of the surface of the spacer 41 to the side of the diffusing plate 15a, the use efficiency of outputted light can be increased. Therefore, the formation of dark areas at portions where the spacer 41 is provided can be suppressed.

Moreover, according to the present embodiment, the spacer 41 is arranged such that the end surface opposite the cold cathode tube 17, that is, the ridge 43 is in contact with the cold cathode tube 17.

In this case, since the distance between the cold cathode tube 17 and the chassis 14 can be suppressed from approaching each other even by a small amount below a design distance, output light intensities of respective cold cathode tubes 17 can be equalized and uniformity of illumination luminance distribution of the backlight unit 12 can be ensured.

In addition, according to the present embodiment, a spacer sheet 40 on which a plurality of spacers 41 is juxtaposed is to be laid onto the chassis 14.

As described above, by forming, in advance, the spacer sheet 40 on which a plurality of spacers 41 are arranged and laying the spacer sheet 40 onto the chassis 14, the hassle of individually forming a plurality of spacers 41 on the chassis 14 can be omitted. Consequently, the assembly efficiency of the backlight unit 12 can be improved.

### Second Embodiment

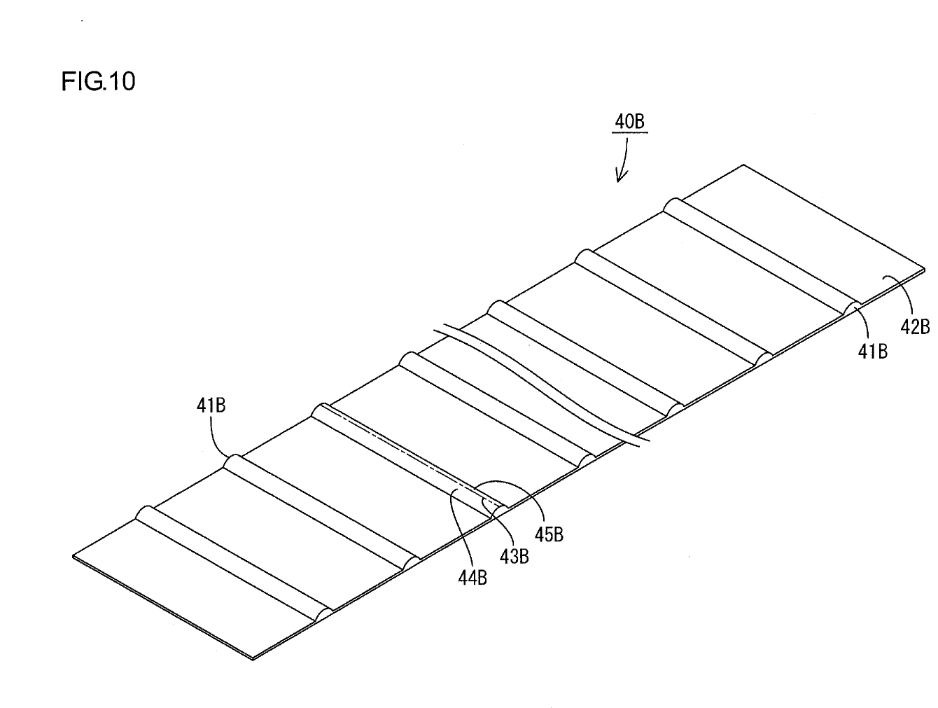

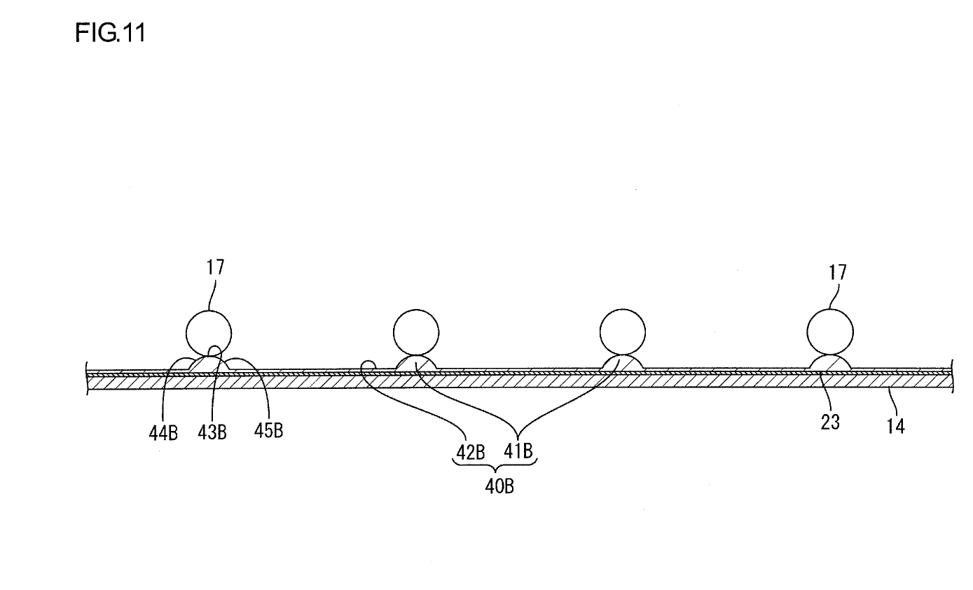

Next, a second embodiment of the present invention will be described with reference to FIGS. 10 and 11. In the present second embodiment, a configuration will be presented where the shape of the spacer has been modified. Otherwise, the present second embodiment is the same as the embodiment described above. Like parts to the embodiment described above will be denoted using like reference characters and redundant descriptions thereof will be omitted.

As illustrated in FIG. 10, a spacer sheet 40B is configured such that a plurality of spacers 41B with approximately semicircular column shapes is juxtaposed on a base plate sheet 42B. In the spacer 41B, an end part opposite a cold cathode tube 17 is formed as a striation 43B. The spacer 41B has peripheral surfaces 44B and 45B that convexly curve from the striation 43B to the base plate sheet 42B. The spacers 41B are aligned so that the striation 43B conforms to a short-side direction of the base plate sheet 42B (spacer sheet 40B).

The spacer sheet 40B described above is pasted to a reflection sheet 23 while conforming a long-side direction of the spacer sheet 40B to a short-side direction of the chassis 14 (a direction of juxtaposition of the cold cathode tubes 17). In this case, as illustrated in FIG. 11, since the spacer 41B comes into contact with the cold cathode tube 17 by the striation 43B or, in other words, by an extremely small area, the spacer 41B does not form dark areas on the cold cathode tube 17. Furthermore, since light emitted from the cold cathode tube 17 to the side of the spacer 41B can be peripherally retrieved along the peripheral surfaces 44B and 45B of the spacer 41B, high outputted light use efficiency can be achieved.

### Third Embodiment

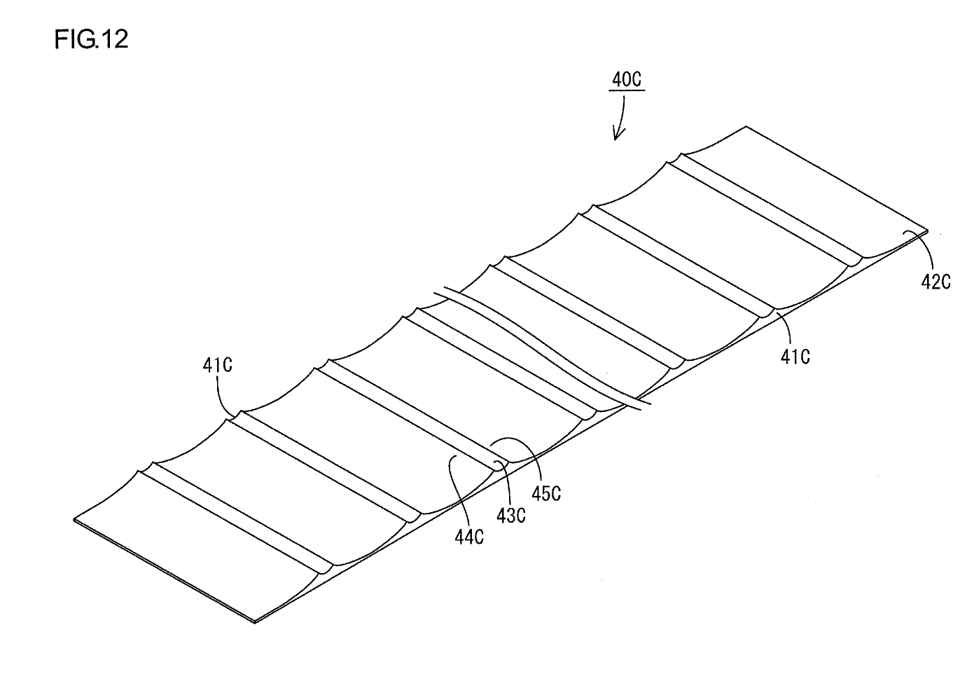

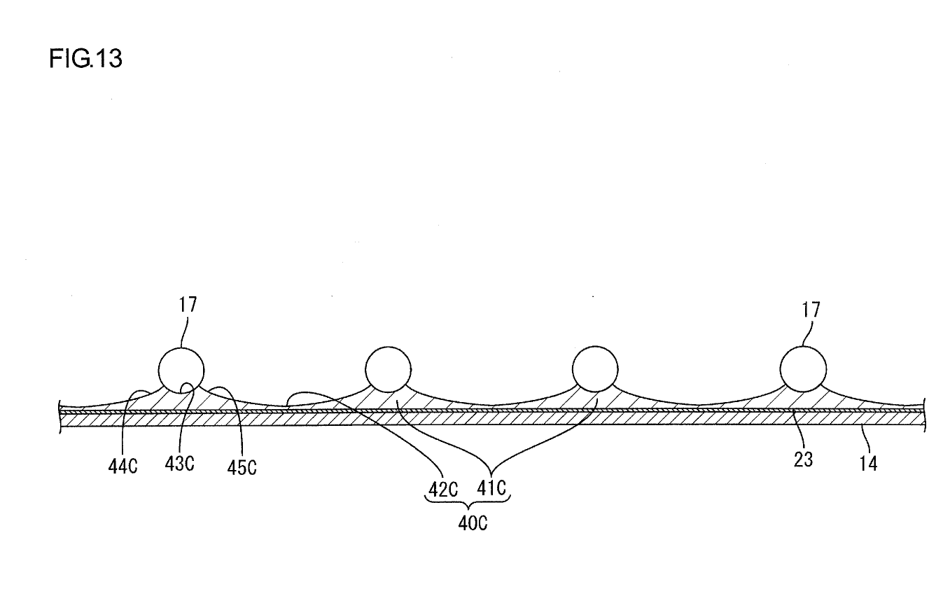

Next, a third embodiment of the present invention will be described with reference to FIGS. 12 and 13. In the present third embodiment, a configuration will be presented where the shape of the spacer has been further modified. Otherwise, the present third embodiment is the same as the embodiments described above. Like parts to the embodiments described above will be denoted using like reference characters and redundant descriptions thereof will be omitted.

As illustrated in FIG. 12, a spacer sheet 40C is configured such that a plurality of approximately wave-shaped spacers 41C whose end surfaces opposite a cold cathode tube 17 are depressed in an arc is juxtaposed on a base plate sheet 42C. In the spacer 41C, the end surface opposite the cold cathode tube 17 is formed as a depressed ridge 43C depressed in an arc. The spacer 41C has curved surfaces 44C and 45C that concavely curve and which form ridge-like shapes that spread from the depressed ridge 43C to the base plate sheet 42C. A curvature of the arc of the depressed ridge 43C is set approximately the same as a curvature of an outer periphery of the cold cathode tube 17.

The spacer sheet 40C described above is pasted to a reflection sheet 23 while conforming a long-side direction of the spacer sheet 40C to a short-side direction of the chassis 14 (a direction of juxtaposition of the cold cathode tubes 17). In this case, as illustrated in FIG. 13, since the spacer 41C comes into contact with the cold cathode tube 17 by the depressed ridge 43C, the spacer 41C can stably support the cold cathode tube 17. Furthermore, since light emitted from the cold cathode tube 17 to the side of the spacer 41C can be peripherally retrieved along the curved surfaces 44C and 45C of the spacer 41C, high outputted light use efficiency can be achieved.

### Fourth Embodiment

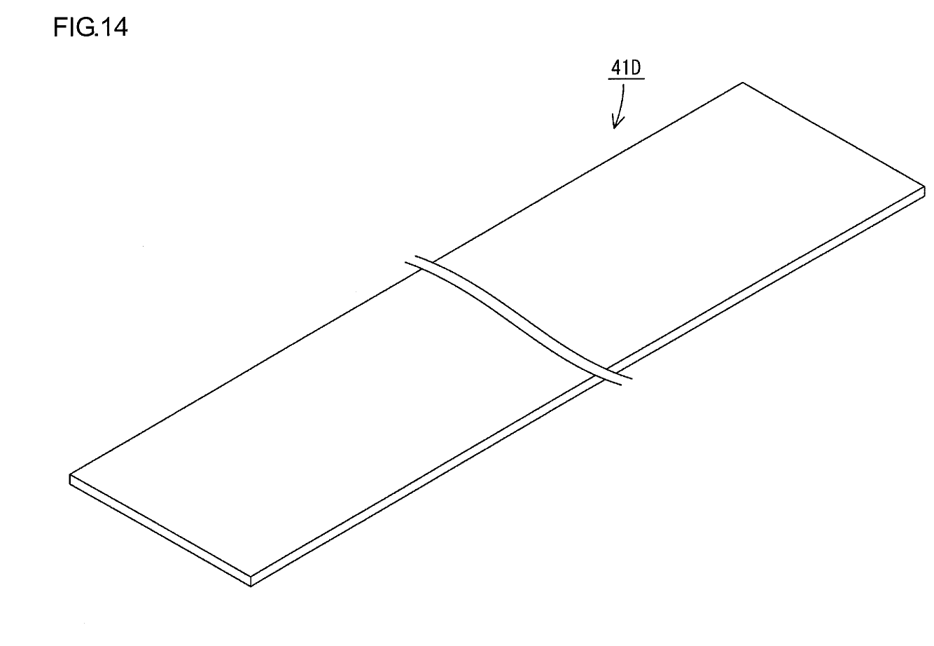

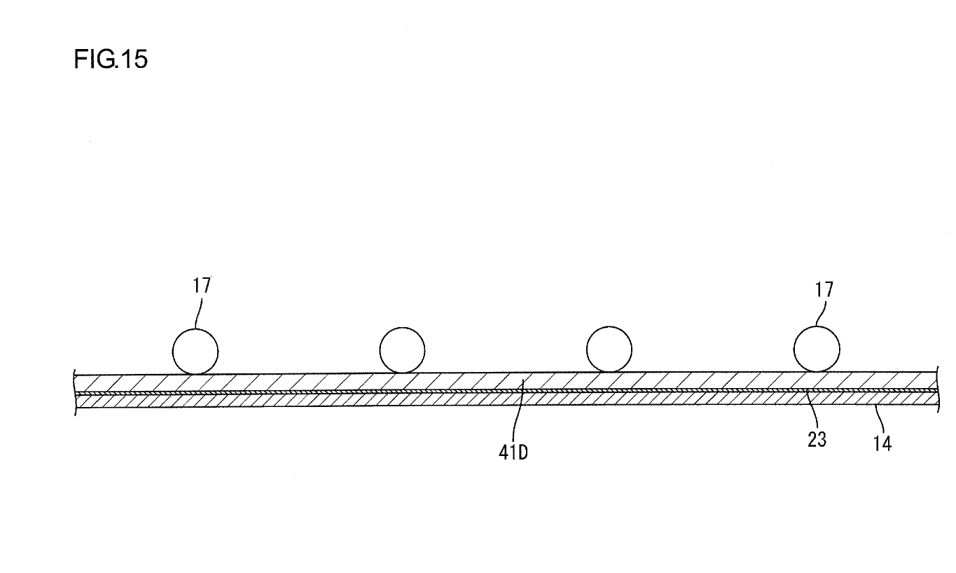

Next, a fourth embodiment of the present invention will be described with reference to FIGS. 14 and 15. In the present fourth embodiment, a configuration will be presented where the shape of the spacer has been further modified. Otherwise, the present fourth embodiment is the same as the embodiments described above. Like parts to the embodiments described above will be denoted using like reference characters and redundant descriptions thereof will be omitted.

A spacer 41D is made of a single plate-like member whose height is set the same as a distance between a cold cathode tube 17 and a reflection sheet 23. In the same manner as the base plate sheets 42 in the embodiments described above, a length of the spacer 41D in a long-side direction thereof is more or less set to a length that enables the spacer 41D to be superimposed across cold cathode tubes 17 arranged at both ends among juxtaposed cold cathode tubes 17. According to such a spacer 41D, time-consuming processing can be omitted and the spacer 41D can be provided at low cost.

The spacer 41D described above is pasted to a reflection sheet 23 while conforming a long-side direction of the spacer 41D to a short-side direction of the chassis 14 (a direction of juxtaposition of the cold cathode tubes 17). In this case, as illustrated in FIG. 15, since the spacer 41D comes into contact with the cold cathode tube 17 by an extremely small area, the spacer 41D does not form dark areas on the cold cathode tube 17.

### Fifth Embodiment

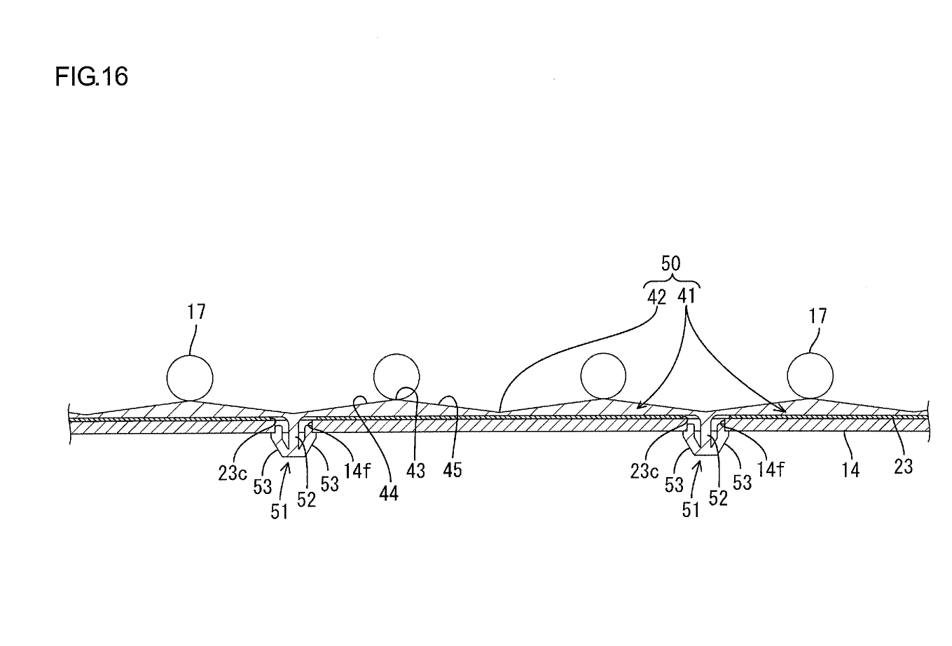

Next, a fifth embodiment of the present invention will be described with reference to FIG. 16. In the present fifth embodiment, a configuration will be presented where fixing means of a spacer sheet has been modified. Otherwise, the present fifth embodiment is the same as the embodiments described above. Like parts to the embodiments described above will be denoted using like reference characters and redundant descriptions thereof will be omitted.

As illustrated in FIG. 16, a spacer sheet 50 is configured such that a plurality of spacers 41 that are protrusion strips with triangular cross sections are arranged on a belt-like base plate sheet 42. More specifically, the spacers 41 are successively formed on a front-side surface (a surface opposite a cold cathode tube 17, a surface on the opposite side to a bottom plate 14a of a chassis 14) of the base plate sheet 42 with slight gaps provided at both end parts of the base plate sheet 42 in the long-side direction thereof. An end surface of the spacer 41 opposite the cold cathode tube 17 forms a linear ridge 43. The spacer 41 is configured so as to include inclined surfaces 44 and 45 that slope from the ridge 43 to the base plate sheet 42.

Meanwhile, a plurality of locking portions 51 for locking the spacer sheet 50 to the chassis 14 is provided on a rear-side surface (a surface opposite a reflection sheet 23, a surface on the opposite side to the cold cathode tube 17) of the base plate sheet 42. Each locking portion 51 is made up of a base portion 52 vertically installed from the base plate sheet 42 and a locking claw 53 provided on a tip of the base portion 52. The locking claw 53 is given a shape that opens in opposite directions in a long-side direction of the base plate sheet 42 from the end part of the base portion 52. The locking claw 53 is made of an elastic member and is configured such that an opening angle of the locking claw 53 changes when stress is applied thereto. Moreover, the locking portion 51 is provided at positions overlapping positions where the inclined surfaces 44 and 45 of the spacer 41 formed on the front-side surface of the base plate sheet 42 intersect with the base plate sheet 42.

The spacer sheet 50 is mounted onto the chassis 14 with the long-side direction of the spacer sheet 50 conformed with the direction of juxtaposition of the cold cathode tubes 17 in the form of being incorporated into a gap between the juxtaposed cold cathode tubes 17 and the chassis 14 (reflection sheet 23). In doing so, the spacer sheet 50 is fixed to the chassis 14 by inserting the locking portions 51 provided on the spacer sheet 50 into locking portion insertion holes 23c and locking portion mounting holes 14f drilled at predetermined positions of the reflection sheet 23 and the chassis 14 and by locking the locking claws 53 to the rear surface-side of the chassis 14.

When locking the spacer sheet 50 to the chassis 14, a portion overlapping the locking portion 51 among the front-side surface of the spacer sheet 50 must be pressed against the chassis 14 from a vertical direction. Therefore, if the locking portion 51 is provided at a position overlapping the ridge 43 of the spacer 41, a suppressing force is to be applied to the spacer 41 that may result in damaging the spacer 41 in some cases. However, in the present embodiment, since the locking portion 51 is formed at a position overlapping positions where the inclined surfaces 44 and 45 of the spacer 41 intersect with the base plate sheet 42 or, in other words, a position overlapping positions where a height-restricting function of the spacer 41 is not enabled, a required suppressing force can be applied.

### Sixth Embodiment

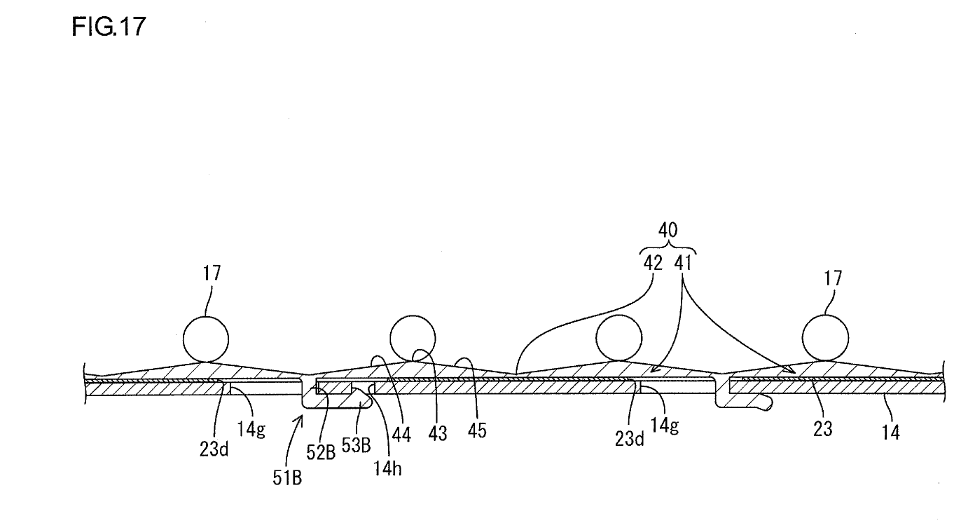

Next, a sixth embodiment of the present invention will be described with reference to FIG. 17. In the present sixth embodiment, a configuration will be presented where fixing means of a spacer sheet has been further modified. Otherwise, the present sixth embodiment is the same as the embodiments described above. Like parts to the embodiments described above will be denoted using like reference characters and redundant descriptions thereof will be omitted.

As illustrated in FIG. 16, a spacer sheet 50B is configured such that a plurality of spacers 41 that are protrusion strips with triangular cross sections are arranged on a belt-like base plate sheet 42. A plurality of locking portions 51B for locking the spacer sheet 50B to the chassis 14 is provided on a rear-side surface (a surface opposite a reflection sheet 23, a surface on the opposite side to the cold cathode tube 17) of the base plate sheet 42. The locking portion 51B is configured in an approximate L-shape made up of a base portion 52B vertically installed from the base plate sheet 42 and a locking claw 53B bent along a bottom plate 14a of the chassis 14 from a tip of the base portion 52B.

The spacer sheet 50B is mounted onto the chassis 14 with the long-side direction of the spacer sheet 50B conformed with the direction of juxtaposition of the cold cathode tubes 17. In doing so, first, the locking portions 51B provided on the spacer sheet 50B are inserted into locking portion insertion holes 23d and locking portion mounting holes 14g drilled at predetermined positions of the reflection sheet 23 and the chassis 14. Next, by sliding the spacer sheet 50B in an extending direction of the locking claw 53B (rightward in FIG. 17), the locking claw 53B is locked to a locking portion mounting hole 14h drilled into the chassis 14 and fixes the spacer sheet 50B to the chassis 14.

### Seventh Embodiment

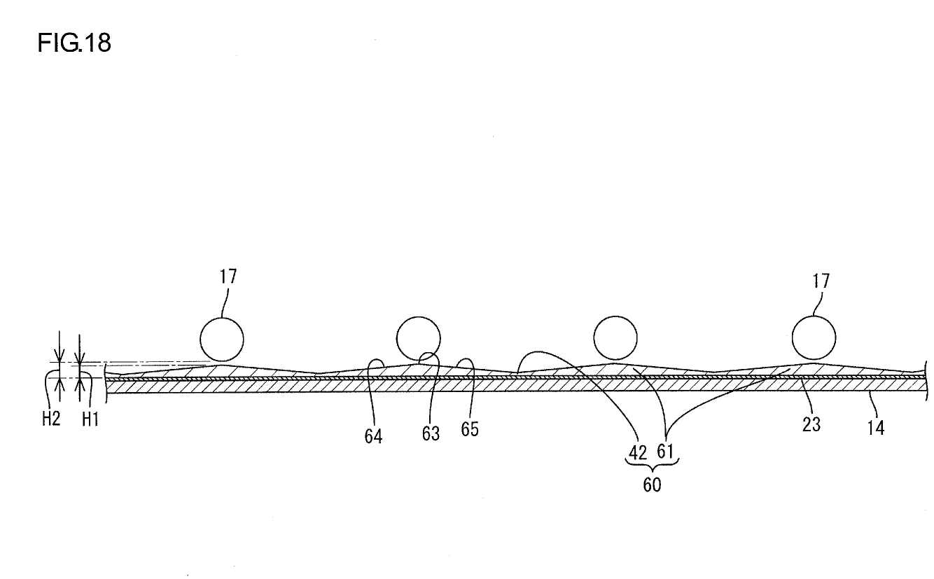

Next, a seventh embodiment of the present invention will be described with reference to FIG. 18. In the present seventh embodiment, a configuration will be presented where a relative positional relationship between a cold cathode tube and a spacer has been modified. Otherwise, the present seventh embodiment is the same as the embodiments described above. Like parts to the embodiments described above will be denoted using like reference characters and redundant descriptions thereof will be omitted.

As illustrated in FIG. 17, a spacer sheet 60 is configured such that a plurality of spacers 61 that are protrusion strips with triangular cross sections are arranged on a belt-like base plate sheet 42. More specifically, the spacers 61 are successively formed on a front-side surface (a surface opposite a cold cathode tube 17, a surface on the opposite side to a bottom plate 14a of a chassis 14) of the base plate sheet 42 with slight gaps provided at both end parts of the base plate sheet 42 in the long-side direction thereof. An end surface of the spacer 61 opposite the cold cathode tube 17 forms a linear ridge 63. The spacer 61 is configured so as to include inclined surfaces 64 and 65 that slope from the ridge 63 to the base plate sheet 42.

In addition, a height from the ridge 63 of the spacer 61 to a rear surface of the base plate sheet 42 or, in other words, a height H1 of the spacer sheet 60 is set to a value described below.

A slight leak occurs from the cold cathode tube 17 to the chassis 14. If the distance between the cold cathode tube 17 and the chassis 14 falls below a predetermined distance, an increase in leakage may cause lighting failure of the cold cathode tube 17. A minimum distance (a critical distance, a threshold distance) between the cold cathode tube 17 and the chassis 14 in a range where lighting failure of the cold cathode tube 17 does not occur is set as the height H1 of the spacer sheet 60. In the present embodiment, the height H1 of the spacer sheet 60 is set slightly shorter than a distance H2 between the cold cathode tube 17 and the reflection sheet 23 (a height at which the cold cathode tube 17 is held).

The spacer sheet 60 described above is pasted to the reflection sheet 23 while conforming a long-side direction of the spacer sheet 60 to a short-side direction of the chassis 14 (a direction of juxtaposition of the cold cathode tubes 17). In this case, since the height H1 of the spacer sheet 60 is set slightly shorter than the distance H2 between the cold cathode tube 17 and the reflection sheet 23, a state is created where a gap is provided between the ridge 63 of the spacer 61 and the cold cathode tube 17. Accordingly, light emitted from the cold cathode tube 17 to the side of the spacer 61 is efficiently peripherally outputted via the gap between the cold cathode tube 17 and the spacer 61. Therefore, formation of dark areas can be suppressed in an extremely efficient manner.

In addition, even in the event where the cold cathode tube 17 and the chassis 14 approach each other due to deflection of the cold cathode tube 17 or distortion of the chassis 14, the spacer 61 is capable of restricting the cold cathode tube 17 and the chassis 14 from approaching each other up to or below a predetermined distance. In other words, while the cold cathode tube 17 approaches the chassis 14 up to the gap between the cold cathode tube 17 and the spacer 61 (a distance expressed as H2−H1 as illustrated in FIG. 18), since the cold cathode tube 17 then comes into contact with the ridge 63 of the spacer 61, the cold cathode tube 17 cannot come any closer to the chassis 14. Therefore, since the distance between the cold cathode tube 17 and the chassis 14 can be kept at the minimum distance (the critical distance, the threshold distance) in a range where lighting failure of the cold cathode tube 17 does not occur, a decline in the illumination quality of the backlight unit 12 can be suppressed.

### Eighth Embodiment

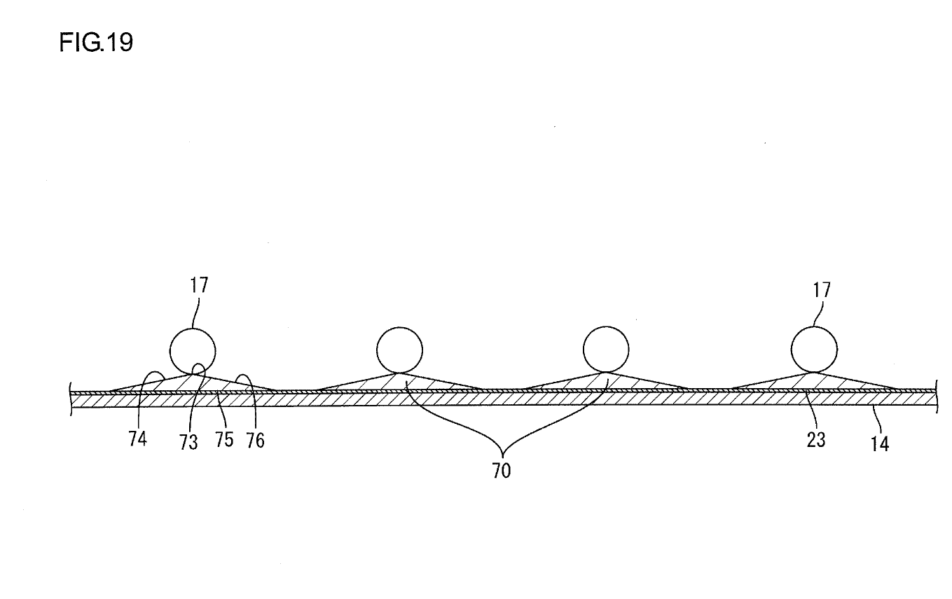

Next, an eighth embodiment of the present invention will be described with reference to FIG. 19. In the present eighth embodiment, a configuration will be presented where the configuration of the spacer has been modified. Otherwise, the present eighth embodiment is the same as the embodiments described above. Like parts to the embodiments described above will be denoted using like reference characters and redundant descriptions thereof will be omitted.

As illustrated in FIG. 19, a spacer 70 is a protrusion strip having a fan-like triangular cross section. A protruding end part of the spacer 70 (an end surface opposite a cold cathode tube 17) forms a ridge 73. The spacer 70 is configured so as to include inclined surfaces 74 and 75 that slope from the ridge 43 at equal angles. In addition, an adhesive layer for pasting the spacer 70 to a reflection sheet 23 is formed on a rear surface 76 (a surface opposite the reflection sheet 23, a surface opposite to the cold cathode tube 17) of the spacer 70. In this case, a height from the ridge 73 to the rear surface 76 or, in other words, a height H3 of the spacer 70 is set the same as a distance H2 between the cold cathode tube 17 and the reflection sheet 23 (a height at which the cold cathode tube 17 is held).

Each spacer 70 described above is pasted to the reflection sheet 23 under the cold cathode tube 17 when viewed in plan. By arranging the ridge 73 of the spacer 70 along an axial direction of the cold cathode tube 17, the ridge 73 comes into line contact (point contact in FIG. 19) with the cold cathode tube 17. Accordingly, since the spacer 70 comes into contact with the cold cathode tube 17 by an extremely small area, the spacer 70 does not form dark areas on the cold cathode tube 17. Furthermore, in the present embodiment, since one each of the spacers 70 can be pasted, spacers 70 can be respectively arranged at desired positions when, for example, a portion of cold cathode tubes 17 that is likely to come close to the chassis 14 differs among the cold cathode tubes 17.

### Other Embodiments

While preferred embodiments of the present invention have been disclosed, the present invention is not limited to the embodiments disclosed by the above description and accompanying drawings and, for example, the embodiments described below also fall within the technical scope of the present invention.

(1) While the first to seventh embodiments described above are configured such that a plurality of spacers is aligned in a single row on a base plate sheet, alignments of the spacers are not limited thereto. For example, a mode involving aligning the spacers in two or more rows may also be adopted.

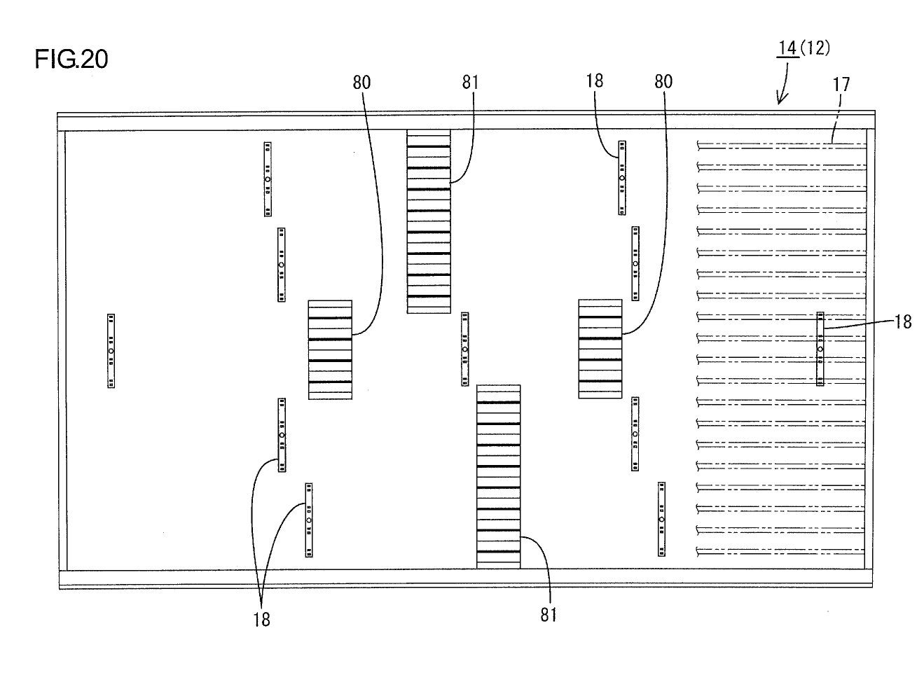

(2) The first to seventh embodiments described above are configured such that spacer sheets are laid across both end parts of a chassis in a short-side direction thereof. However, as illustrated in FIG. 20, a spacer sheet may be adopted that is laid only on a part of a chassis 14 such as a center-side spacer sheet 80 or an end part-side spacer sheet 81.

(3) While triangular, half-circular, and wave-shaped cross-sections of a spacer have been exemplified in the embodiments described above, cross-sectional shapes of the spacer are not limited thereto. For example, other spacers with trapezoidal, polygonal, and other cross-sectional shapes are to be also included in the present invention.

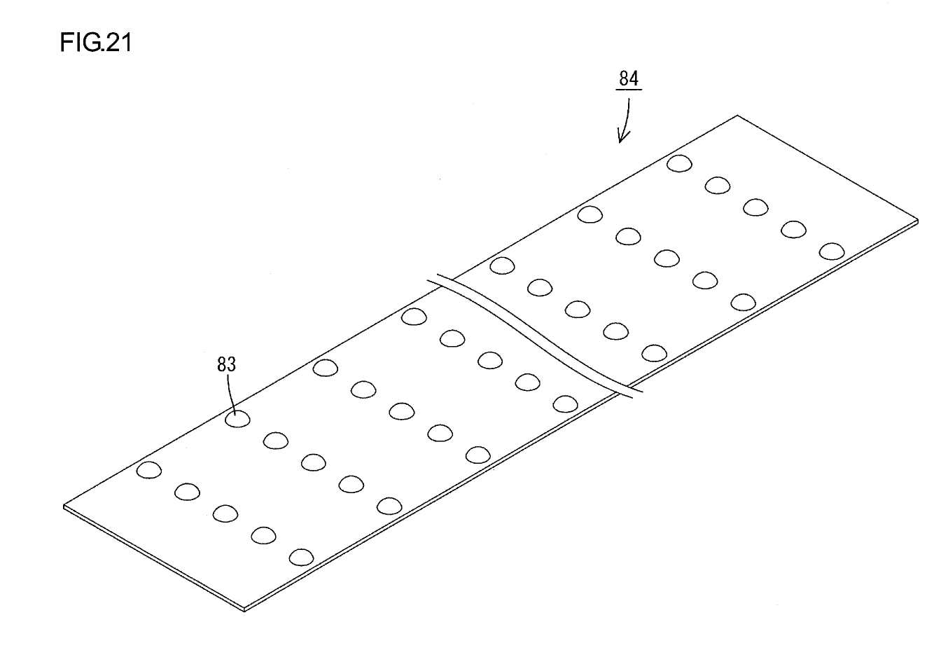

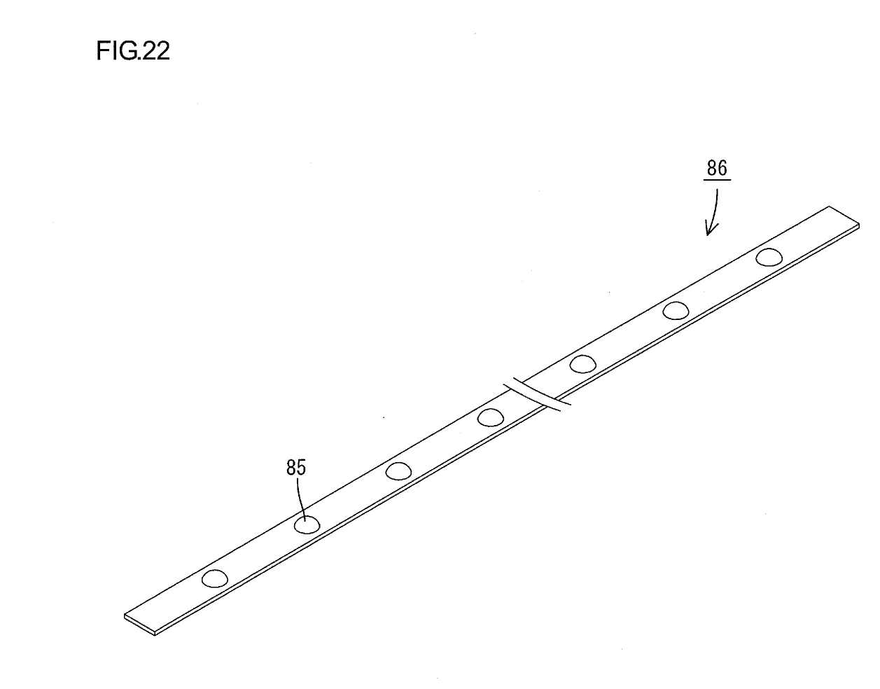

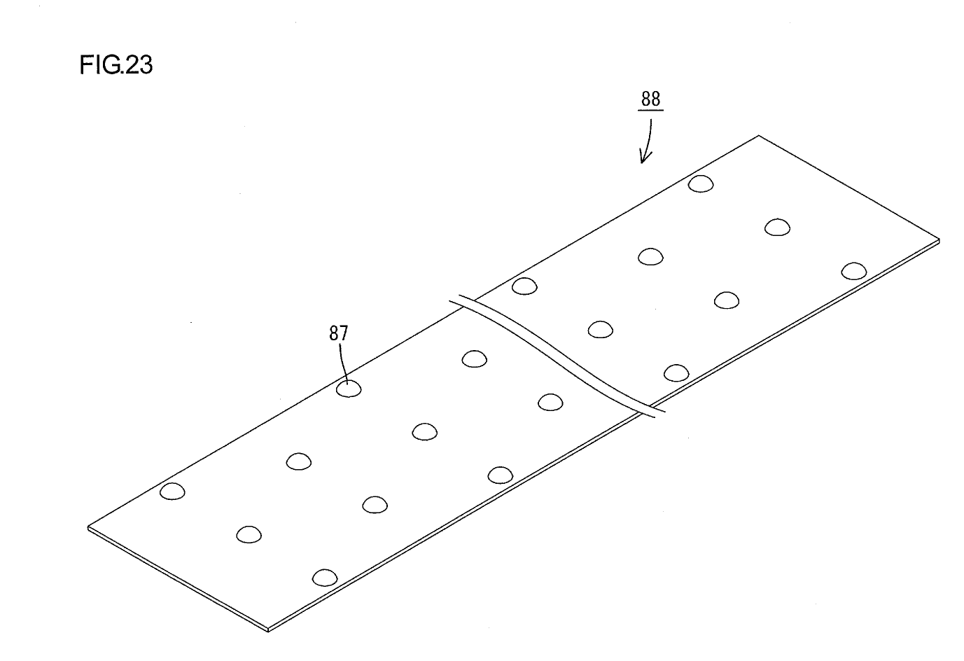

(4) While a spacer that is rectangular in plan view and having a longitudinal direction along an axial direction of a cold cathode tube has been exemplified in the embodiments described above, for example, as illustrated in FIG. 21, a spacer sheet 84 may be used on which a plurality of spacers 83 that are circular in plan view is arranged. In addition, as illustrated in FIG. 22, a spacer sheet 86 may be used on which a plurality of spacers 85 that are circular in plan view is aligned in a single row. Furthermore, as illustrated in FIG. 23, a spacer sheet 88 may be used on which a plurality of spacers 87 that are circular in plan view is arranged in a zigzag pattern. Moreover, in addition to spacers that are circular in plan view, spacers with other plan-view shapes such as those that are triangular or quadrate in plan view are to be also included in the present invention.

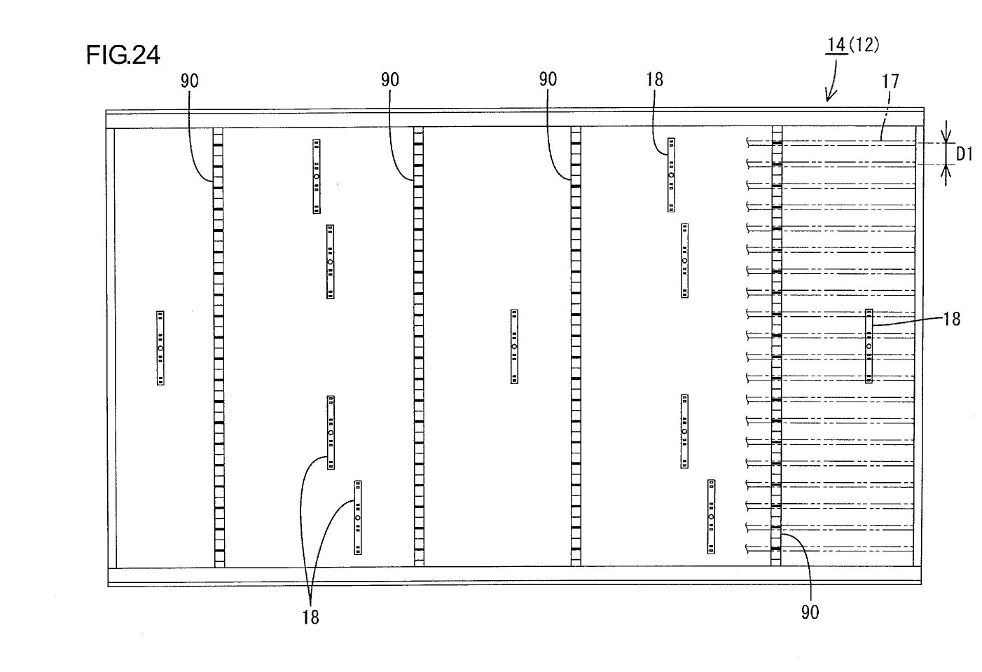

(5) A wide spacer sheet on which spacers are arranged with longitudinal directions of the spacers conformed with an axial direction of a cold cathode tube has been exemplified in the embodiments described above. However, for example, as illustrated in FIG. 24, a narrow spacer sheet 90 may also be used on which spacers are arranged with longitudinal directions of the spacers conformed with a direction of juxtaposition of the cold cathode tubes. In other words, a narrow spacer sheet 90 on which spacers with relatively short striation-direction lengths are arranged may also be used.

(6) While cases where a cold cathode tube 17 is used as a light source have been described in the embodiments above, cases using other light sources such as a hot cathode tube are to be also included in the present invention.

1. An illumination device comprising: a linear light source;
a chassis housing the linear light source; and
a spacer provided between the linear light source and the chassis so as to separate the linear light source from the chassis, wherein
the spacer is arranged under the linear light source when viewed in plan.

2. The illumination device according to claim 1, further comprising a plurality of light source gripping members gripping the linear light source so as to hold the linear light source away from the chassis, wherein:
the light source gripping members are arranged away from each other in an axial direction of the linear light source; and
the spacer is arranged between the light source gripping members on the chassis.

3. The illumination device according to claim 1, wherein the spacer has a ridge-like shape that spreads towards a chassis side.

4. The illumination device according to claim 1, wherein the spacer is formed such that a width of a surface that is opposite the linear light source is smaller than a width of the linear light source.

5. The illumination device according to claim 1, wherein the spacer has a surface made of a light-reflective material.

6. The illumination device according to claim 1, wherein the spacer is arranged such that a gap is provided between the spacer and the linear light source.

7. The illumination device according to claim 1, wherein the spacer is arranged so as to be in contact with the linear light source.

8. The illumination device according to claim 1, further comprising a sheet having a plurality of spacers, wherein
the sheet is placed on such that the spacers are positioned under the linear light source when viewed in plan.

9. A display device comprising:
the illumination device according to claim 1; and
a display panel for providing display using light from the illumination device.

10. The display device according to claim 9, wherein the display panel is a liquid crystal panel using liquid crystals.

11. A television receiver apparatus comprising the display device according to claim 9.
